(19) United States
(12) Patent Application Publication
(10) Pub. No.: US 2025/0088703 A1
(43) Pub. Date: Mar. 13, 2025

(54) Systems and Methods for Creating and Delivering Interactive Multimedia Sessions with Real-Time User Feedback

(71) Applicant: Marcia M Peng, Methuen, MA (US)

(72) Inventor: Marcia M Peng, Methuen, MA (US)

(73) Assignee: Marcia Man PENG, Methuen, MA (US)

(21) Appl. No.: 18/830,579

(22) Filed: Sep. 11, 2024

Related U.S. Application Data
(60) Provisional application No. 63/538,043, filed on Sep. 12, 2023.

(51) Int. Cl. H04N 21/431; H04N 21/475

(52) U.S. Cl. CPC H04N 21/4316; H04N 21/475

(57) ABSTRACT

The present invention introduces systems and methods for creating and delivering interactive multimedia content on a scalable platform, providing real-time user engagement, biofeedback integration, and personalized content recommendations. It includes a creator interface for inputting multimedia segments, designing user interactions, and integrating them into a content data package following a predefined protocol. A user interface delivers interactive content to users and collects their responses during predefined interaction periods and feedbacks before and after the multimedia session. The invention supports customizable features such as feedback mechanisms (e.g., questionnaires), scalable content distribution, biofeedback integration, and real-time user engagement analysis. These tools enable creators to design personalized and interactive multimedia experiences for various applications, such as therapy, education, and entertainment.

### BACKGROUND OF THE INVENTION

Hypnosis, sometimes referred to as a form of guided meditation, is a technique for communicating with the subconscious mind, which controls many aspects of both mental and physical well-being. Hypnotherapy utilizes hypnosis to address deeply rooted issues within the subconscious. In traditional one-on-one hypnotherapy, a hypnotist guides the client into a deeply relaxed, dream-like state where the conscious, critical mind is bypassed, allowing direct access to the subconscious for therapeutic intervention.

A typical hypnotherapy session involves voice communication, where the hypnotist speaks while the client listens with closed eyes. Throughout the session, the hypnotist may ask the client to respond to questions or prompts to ensure that the subconscious mind is engaged and following the session's guidance. These interactions, such as verbal responses or simple finger movements, are essential for achieving effective therapeutic results.

One-on-one hypnotherapy can be costly, putting it out of reach for many individuals, especially amid a growing mental health crisis. As a result, those in need of treatment often remain untreated due to financial barriers.

Pre-recorded hypnotherapy sessions, or digital hypnotherapy, offer reduced costs, 24/7 accessibility, and an additional revenue stream for hypnotists. However, the current systems in use often rely on static, pre-recorded content with little to no user interaction, and do not offer the ability to customize sessions based on the hypnotist's goals or the individual needs of the user. Additionally, collecting client feedback for each session is often difficult and expensive, limiting opportunities to improve session effectiveness. This lack of real-time interaction and feedback reduces the overall efficacy of such sessions.

Similarly, in fields such as education, entertainment, and other forms of digital therapy, there is an increasing need for systems that go beyond static content to offer real-time interaction and adaptability. Existing solutions in these areas also lack the flexibility to incorporate real-time feedback and customization based on user responses, resulting in a less engaging experience for the user.

There is a growing demand for interactive systems that enable hypnotists (or other content creators) to design and deliver personalized hypnotherapy sessions (or other digital content) with real-time user engagement and integrated feedback mechanisms. Such systems would make feedback collection more accessible and cost-effective, while allowing creators across various fields to craft dynamic, responsive experiences tailored to individual user behavior, significantly enhancing both the content's efficacy and user engagement.

### SUMMARY OF THE INVENTION

The present invention provides systems and methods for creating and delivering interactive multimedia sessions designed to engage users in real time and collect feedback based on their responses. The system includes a creator interface that enables hypnotists or other content creators, such as educators and therapists, to input multimedia content, design user interaction periods, and integrate customizable feedback mechanisms such as questionnaires. Through this interface, creators can easily structure sessions to adapt dynamically to user input, providing a personalized experience tailored to individual needs.

A user interface delivers the multimedia content to users and collects their responses during predefined interaction periods, allowing for real-time engagement and the seamless collection of feedback. This feedback can be used to optimize the session content or adjust the flow of future sessions, ensuring that each experience is responsive and tailored to the user's behavior.

The system is further equipped with scalable content delivery capabilities, enabling sessions to be accessed across multiple devices and enabling users to pause and resume sessions without losing progress.

The platform's design ensures ease of use for content creators, making it adaptable to a wide range of applications, including but not limited to hypnotherapy, guided meditation, educational training, entertainment, and therapeutic interventions. By combining real-time user engagement with customizable content creation, the invention offers a powerful and flexible tool for delivering interactive multimedia experiences across various domains.

While the primary focus of this system is on the design and delivery of personalized hypnotherapy sessions, the flexible nature of the platform makes it adaptable to a wide range of other applications. The system's creator interface, which allows for the integration of multimedia content, user interaction periods, and real-time feedback mechanisms, can be easily utilized by professionals in fields beyond hypnotherapy. For instance, educators, therapists, and content creators in fields such as entertainment or training can use the system to deliver interactive and responsive multimedia sessions tailored to user input.

### BRIEF DESCRIPTION OF FIGURES AND DRAWINGS

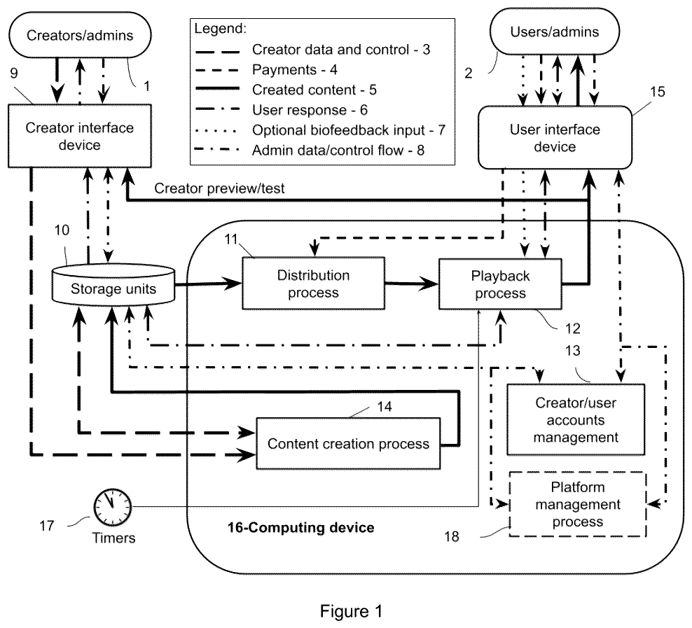

1. FIG. 1: Functional diagram of the invented platform, showing interconnected hardware devices and software processes used for creating and delivering interactive hypnotherapy content.

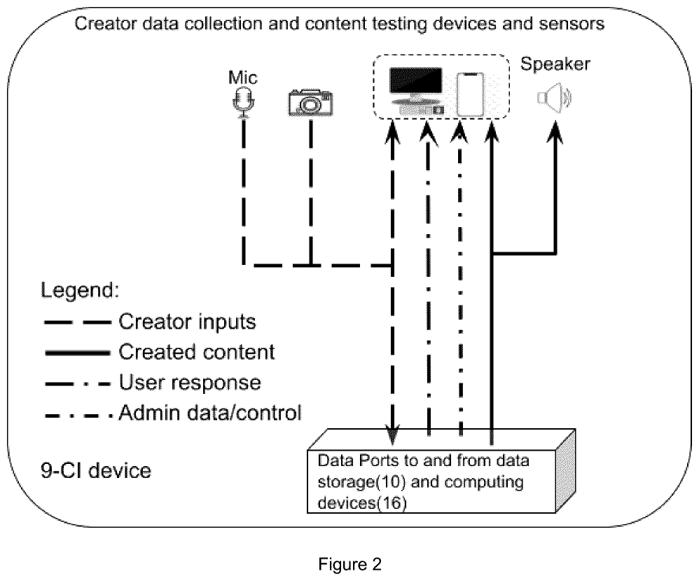

2. FIG. 2: Functional illustration of a creator interface (CI) device (9), used for collecting multimedia inputs and designing user interaction periods.

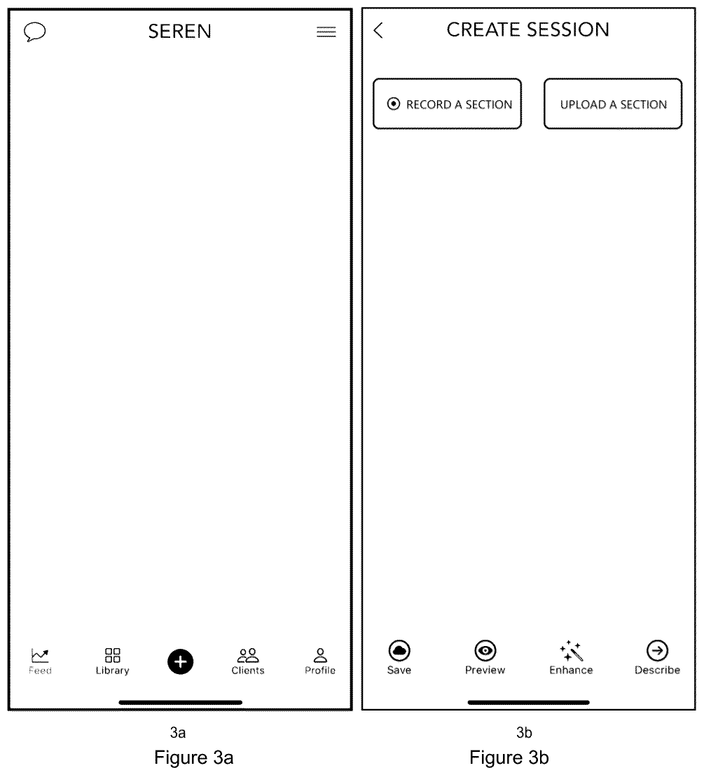

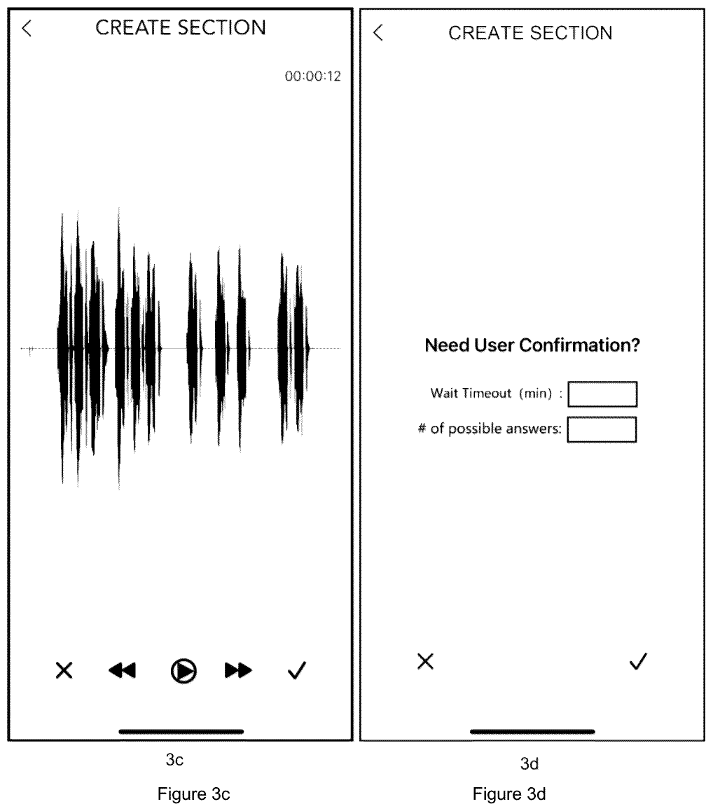

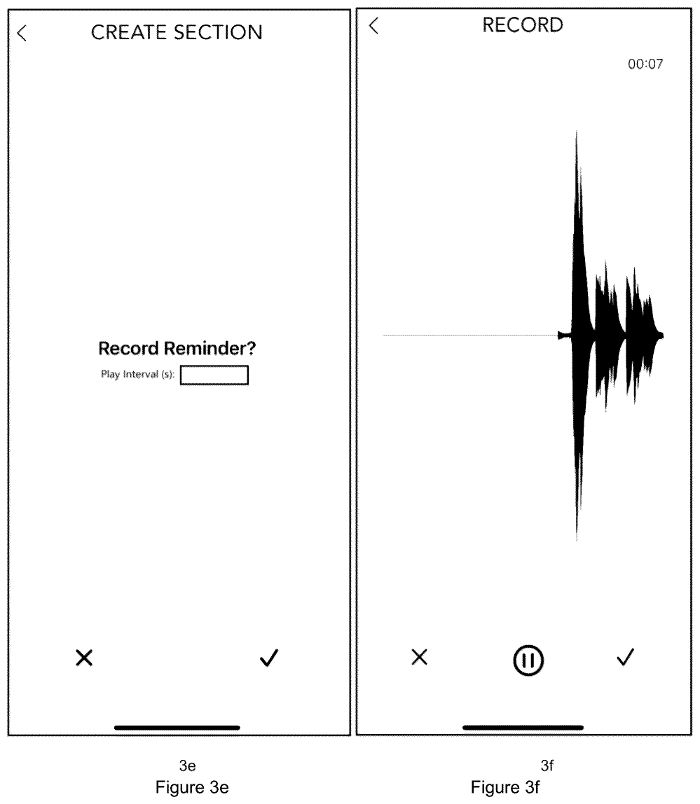

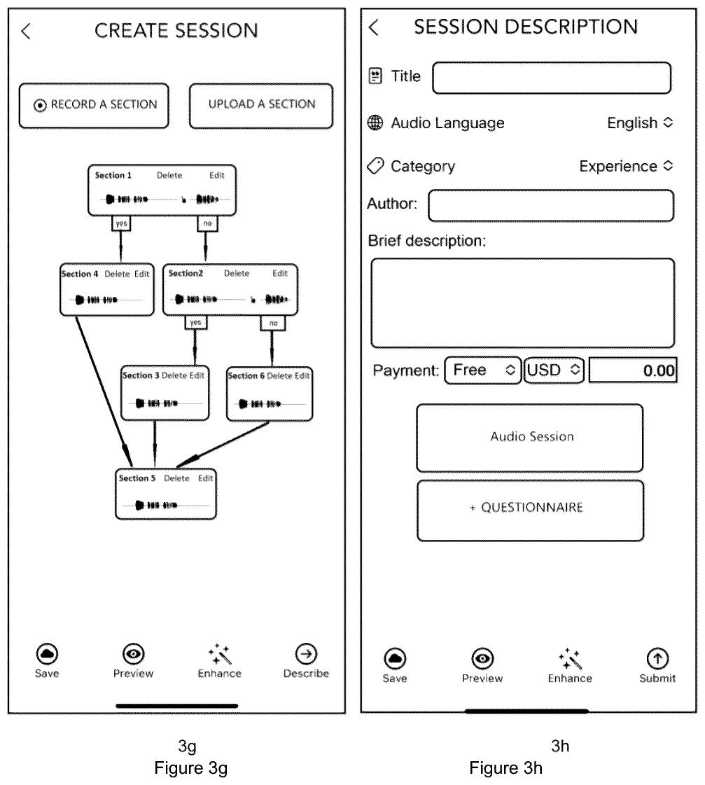

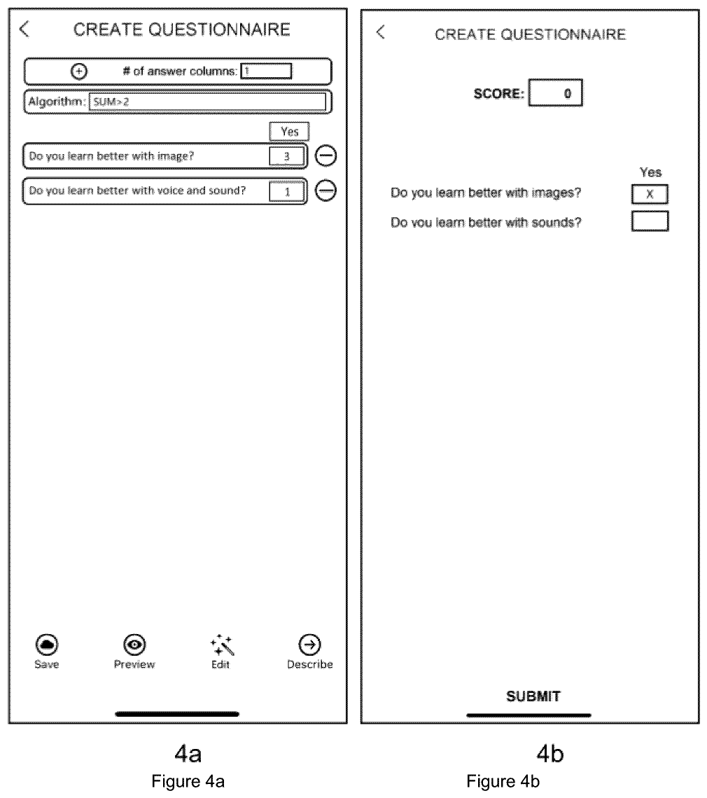

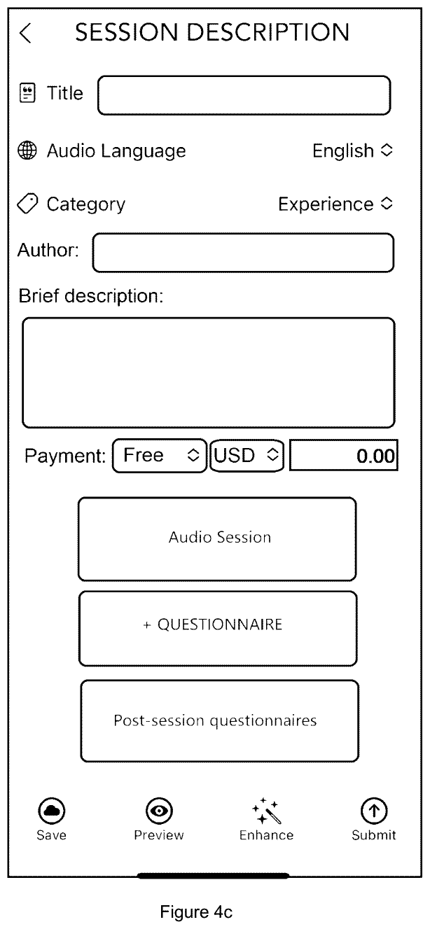

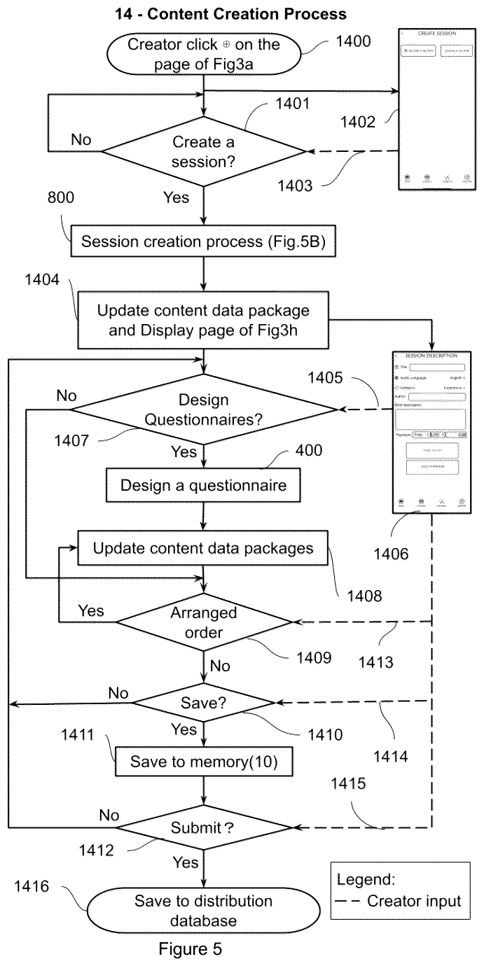

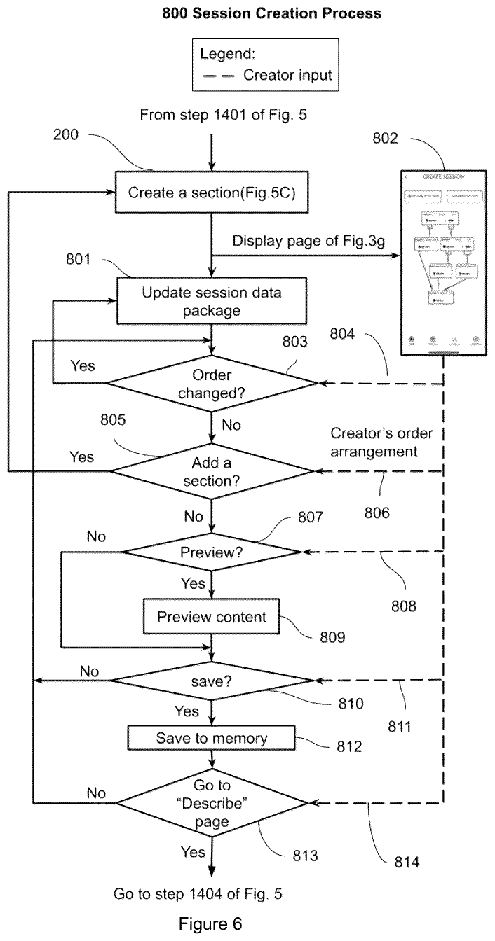

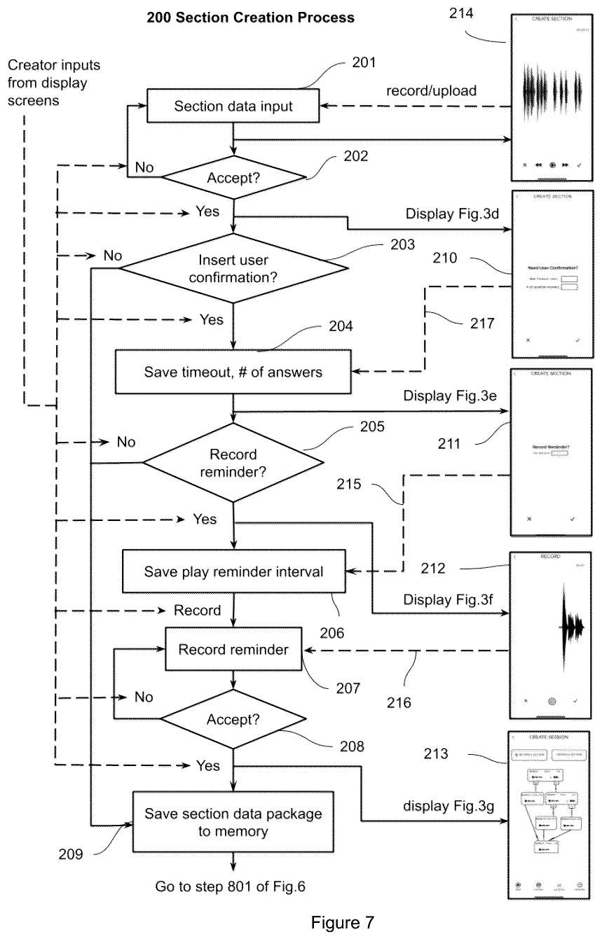

3. FIG. 3a: Creator home page, where pressing the ‘@’ button at the bottom initiates the content creation process.

4. FIG. 3b: Session creation page, where creators can either click ‘RECORD A SECTION’ to capture new content or ‘UPLOAD A SECTION’ to input an existing section.

5. FIG. 3c: Section input page, where a multimedia section can be saved using the ‘V’ button or discarded with the ‘X’ button.

6. FIG. 3d: Interaction period configuration page, where creators can optionally add (‘V’) and configure an interaction period for user engagement.

7. FIG. 3e: Reminder configuration page, where creators can optionally add (‘V’) and configure a reminder clip to be played during the interaction period.

8. FIG. 3f: Reminder recording page, allowing creators to record a reminder clip, save it using the ‘V’ button, or discard it using the ‘X’ button.

9. FIG. 3g: Session creation page displaying several created sections arranged in a specific order. The order of sections can be changed by dragging section icons to new positions.

10. FIG. 3h: Session description page, where creators can describe the session, assign attributes, and design questionnaires using the ‘+QUESTIONNAIRE’ button. The ‘Submit’ button sends the session for publication approval.

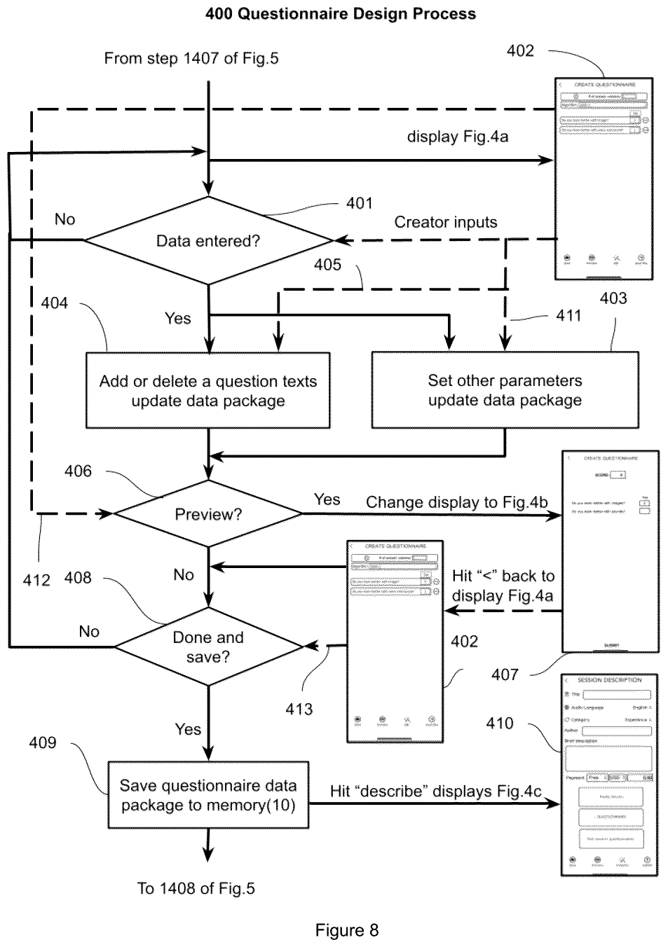

11. FIG. 4a: Questionnaire design page, featuring buttons to ‘Save’, ‘Preview’, or ‘Edit’ the questionnaire during its creation.

12. FIG. 4b: Questionnaire preview page, where the back button (′<′) returns the creator to the design page (FIG. 4a).

13. FIG. 4c: Session description page displaying a post-session questionnaire created by the creator.

14. FIG. 5: Flowchart illustrating the content creation process (14), where sections and interaction periods are defined.

15. FIG. 6: Flowchart illustrating the session creation process, including the steps for adding sections and interaction periods.

16. FIG. 7: Flowchart illustrating the section creation process, detailing how sections are recorded, configured, and added to a session.

17. FIG. 8: Flowchart illustrating the questionnaire design process, where creators can customize questions, scoring, and review options.

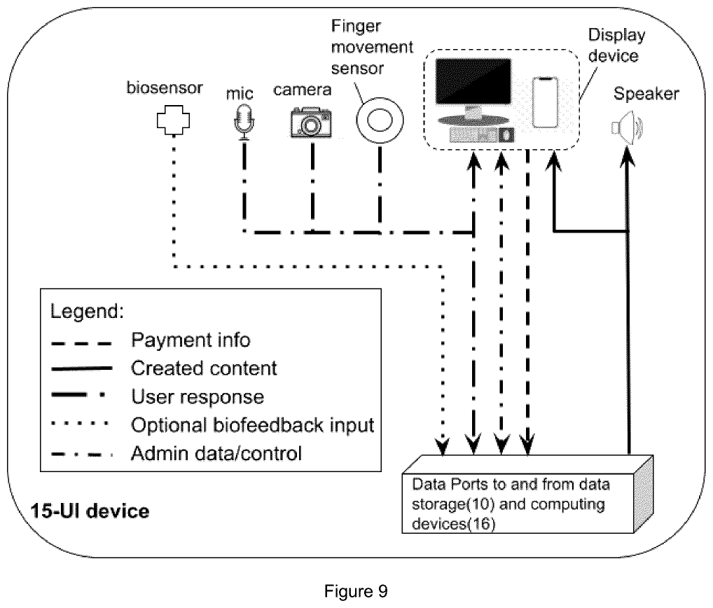

18. FIG. 9: Functional illustration of a user interface (UI) device (15), used for delivering content and collecting user responses during the session.

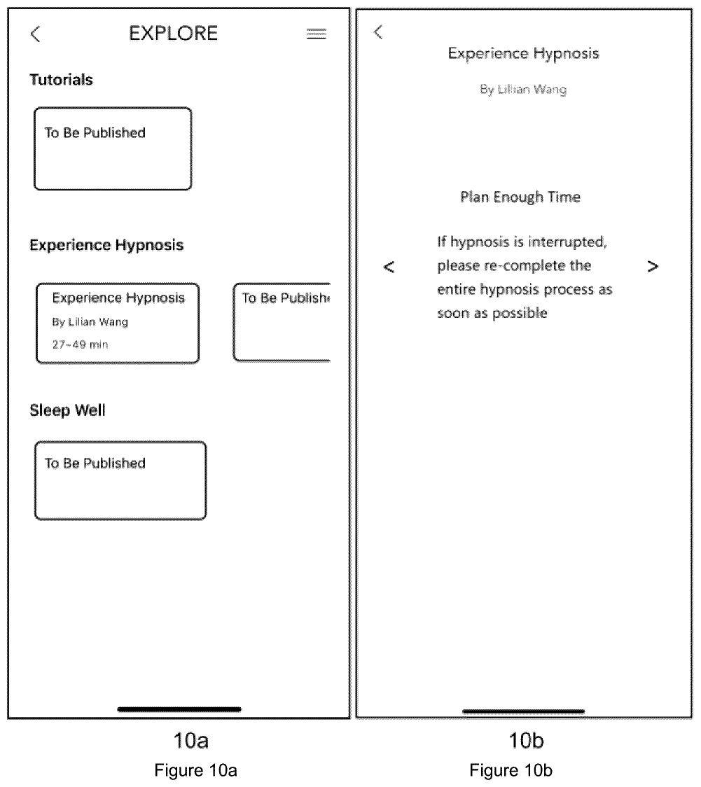

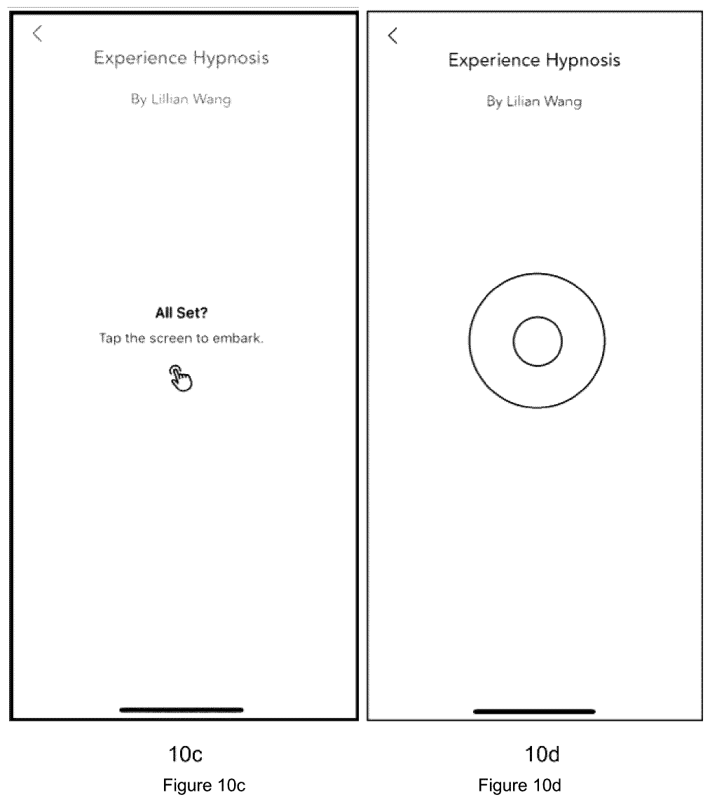

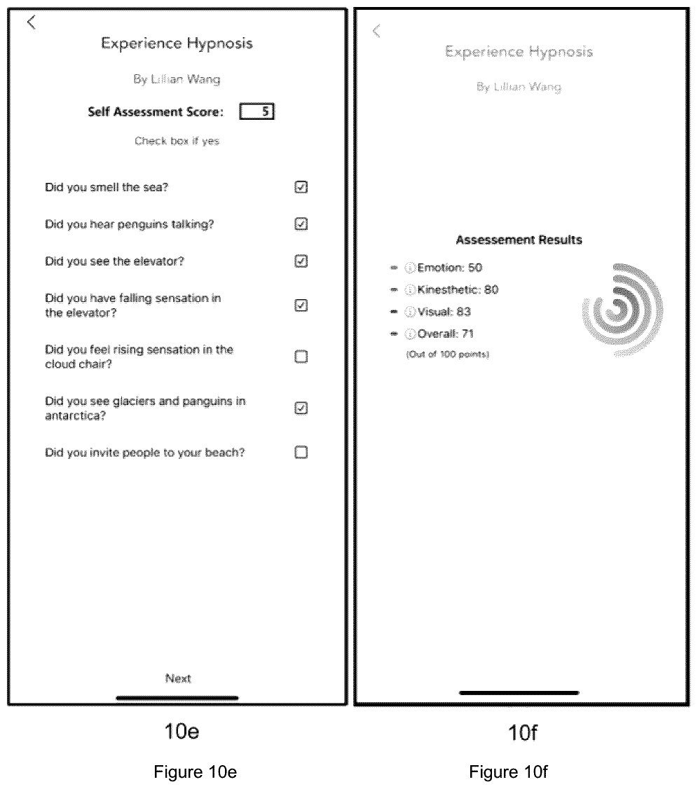

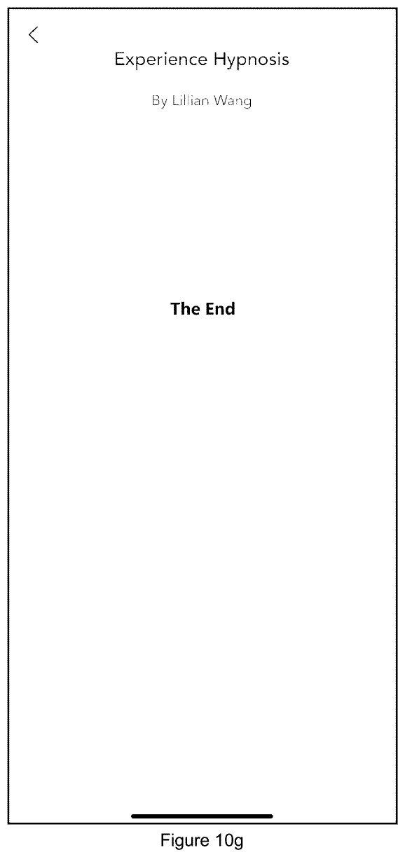

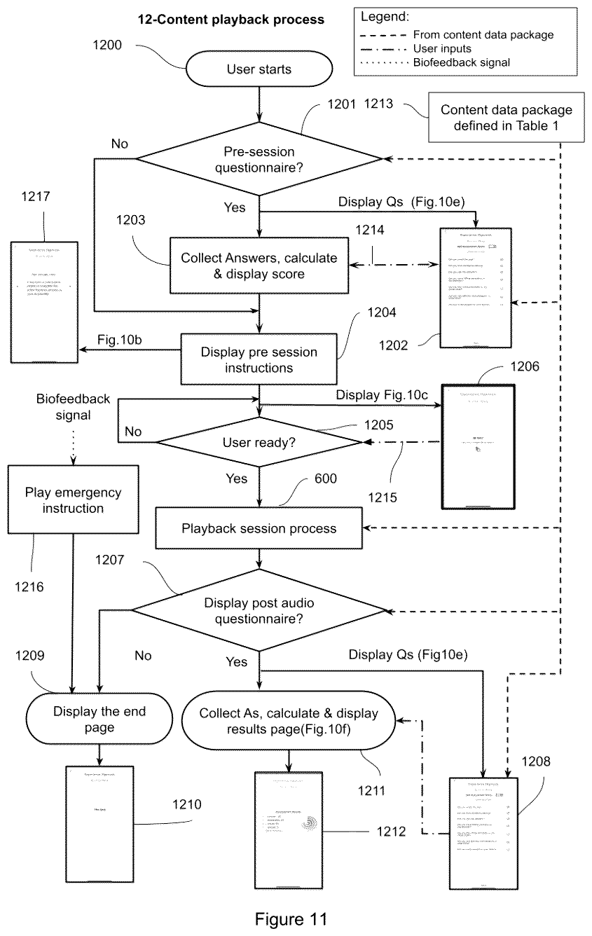

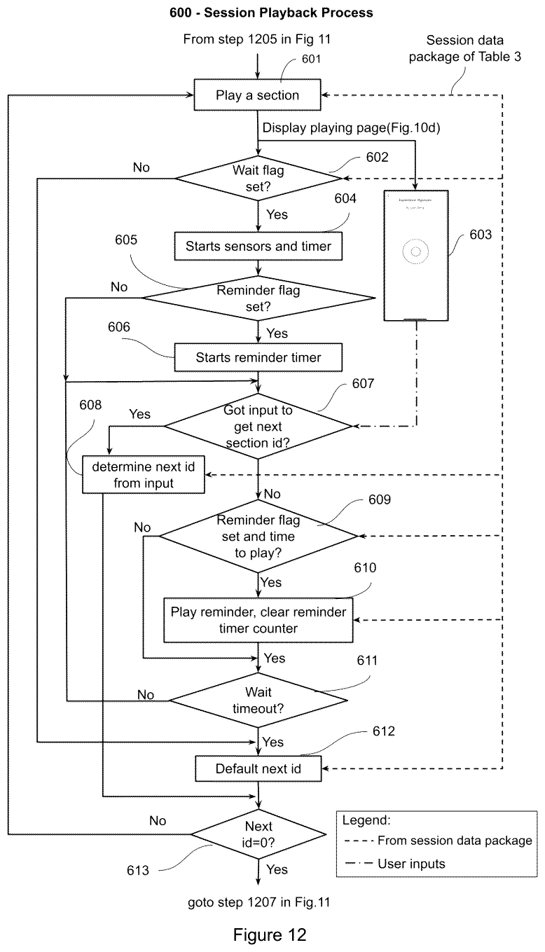

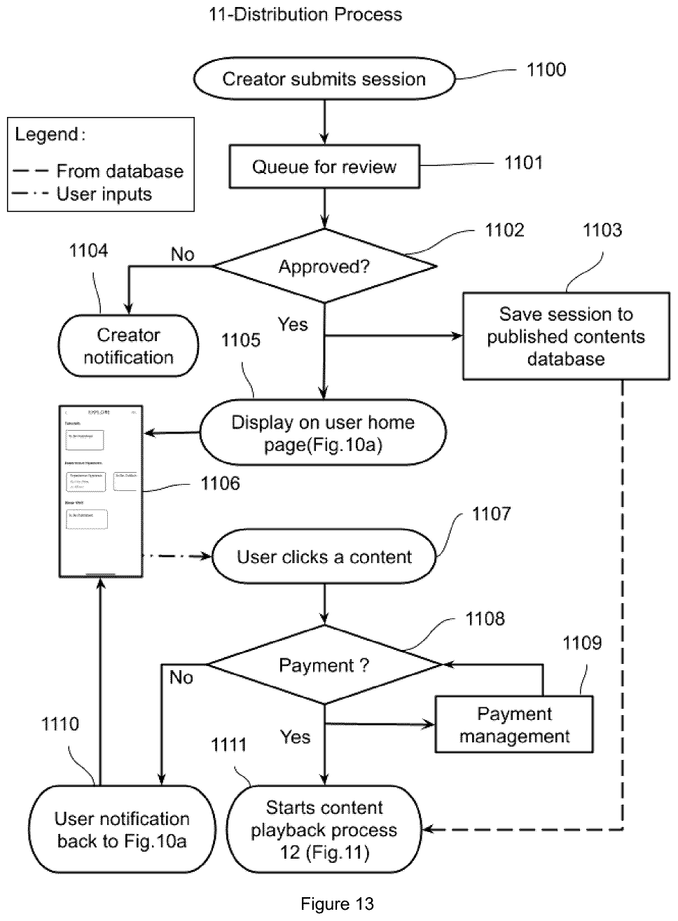

19. FIG. 10a: User home page displaying a list of created hypnotherapy sessions available for selection.

20. FIG. 10b: Pre-session instruction page, providing guidance before the session begins.

21. FIG. 10c: Page prompting the user to start the session.

22. FIG. 10d: Session playback page, showing the multimedia hypnotherapy content in progress.

23. FIG. 10e: Post-session questionnaire display page, collecting feedback from the user after the session.

24. FIG. 10f: Session ending page, displaying questionnaire results. The back button (′<′) returns the user to the home page (FIG. 10a).

25. FIG. 10g: Simple ‘The End’ page displayed at the completion of the content playback. The back button (′<′) returns the user to the home page (FIG. 10a).

26. FIG. 11: Flowchart illustrating the content playback process, including how pre-session and post-session questionnaires are handled.

27. FIG. 12: Flowchart illustrating the session playback process, detailing the sequence of sections and interaction points.

28. FIG. 13: Flowchart illustrating the publication control process, where submitted content is reviewed, approved, and distributed.

### DETAILED DESCRIPTION OF THE INVENTION

The present invention addresses the aforementioned demand by providing systems and methods that allows hypnotists to design their own interactive sessions and ensures that the created digital hypnotherapy content is delivered to users exactly as intended. Through a creator interface, hypnotists can structure multimedia content, set user interaction periods, and design real-time feedback collection mechanisms to tailor sessions to each individual's needs and to improve further session design. While the invention is particularly useful for hypnotherapy, the system's design flexibility also makes it suitable for a wide range of interactive multimedia applications, including meditation, education, entertainment, and other forms of guided experiences.

In the following sections, every aspect of this invention will be explained in detail. The terms in the following glossary are frequently used throughout.

### Glossary

Content: The final digital product designed and produced by a creator using this invention, consisting of sessions and questionnaires.

Creator: a person who uses this invention to design and produce content.

Data package: Information and data related to a section, session, questionnaire, or content, stored in a predefined format.

Interaction period: A period during the stream flow, before the end of a session, in which user responses to the session content are sensed and acted upon.

Protocol: A predefined format governing the structure of various data packages.

Questionnaire: A part of the content that includes a list of questions, designed by the creator, to be displayed before and/or after the session.

Reminder: A short voice or video clip played during an interaction period to prompt the user to take action.

Repetition interval: The time measured between the beginning of one reminder and the start of the next reminder.

Section: A smaller part of a session, consisting of a multimedia component, and optionally including a designed interaction period.

Session: The complete multimedia portion of the content, including all sections and interaction periods.

User: A person who consumes the created content. A person can fulfill both roles as creator and user.

An overview of this invention is shown in FIG. 1, which includes the following major components:
1. Creator interface (CI) devices (9) (shown in FIG. 2) allow creators to input multimedia segment data, insert and configure user interaction periods, design questionnaires, and preview the created content. Example embodiments of this interface include user interface (UI) devices of mobile phones or laptops.
2. User interface (UI) devices (15) (shown in FIG. 9) deliver interactive digital hypnotherapy to users, collect responses during interaction periods, and gather questionnaire feedback before or after a session. These devices can be general-purpose mobile phones or laptops. Both the CI devices (9) and UI devices (15) can also be used by administrators to execute platform maintenance processes. Creators, users, and administrators may share the same devices if all necessary functions and components are available . . .
3. Non-transitory computer-read-and-writable data storage units (10), or memory, are connected to the interface devices (9 and 15) and computing devices (16), either locally or through the cloud. These storage units are used to store created content, design drafts, and related data.
4. Computing devices (16) are connected to the data storage units (10) and interface devices (9 and 15). These devices are responsible for executing the following processes:
   a. An automated content creation process (14) that collects and integrates creators' multimedia (audio, image, video, text, etc) data, user interaction designs, and questionnaire inputs from the CI devices into data packages defined by a protocol, then stores them in the storage units (10).
   b. An intelligent distribution process (11) that controls user access to the created digital content based on the creators' settings. It manages payment accounts and the content approval process.
   c. An automated playback process (12) that parses content data packages, plays the interactive digital content, displays designed questionnaires according to the predefined protocol, collects and analyzes user responses, displays the results on the UI device (15), and stores them in the storage units (10).
   d. A creator and user account management process keeps track of individual information, activities, and inter-account relationships.
   e. An automated platform management process (13) handles device and task configuration, scheduling, and synchronization. These service modules are typically available in mobile phones and laptops.

This invention may integrate with certain existing prior art modules. In the following explanation, we will focus on detailing the novel modules while referencing prior art modules for completeness in describing the overall functionality.

For clarity, the invention is divided into three parts: systems and methods for creators, systems and methods for users, and systems and methods for both creators and users. These parts may share devices, data, and other resources.

### Systems and Methods for Creators

FIG. 2 depicts a possible embodiment of the CI device (9 in FIG. 1), which includes data collection components (e.g., camera, microphone, keyboard, touch screen, data input sensors, and ports) and content display components (e.g., screen and speaker). The CI devices (9) are also connected to both the Computing Devices (16 in FIG. 1) and the Storage Units (10 in FIG. 1). In addition to their primary functions of collecting creators' inputs and previewing created content, the CI devices can also serve as interface devices for system administrators.

Without limitation, one possible embodiment of the CI device (9) is a mobile phone with specially designed display interfaces, an example of which is illustrated in FIGS. 3a-3h.

The core concept of the invented Content Creation Process (14 in FIG. 1) is that creators divide a digital hypnotherapy session into smaller sections. They have the option to insert a stop-wait-sense-go (SWSG) user interaction mechanism, also referred to as an interaction period, between any two sections. Additionally, creators can design pre-session and post-session questionnaires if desired. The system then automatically integrates all sections, the inserted SWSG functions, and the designed questionnaires into a content data package, following a predefined format or protocol. During playback, the Playback Process (12) parses the content data package using the same protocol to deliver the content exactly as designed.

In addition to its use in hypnotherapy, this system can be applied to a variety of other fields, such as education, cognitive therapy, and interactive entertainment, where real-time user engagement is essential. For example, educators may use the system to create interactive lessons, where students' real-time responses are used to adapt future content. Therapists, particularly in cognitive behavioral therapy or meditation, can benefit from delivering personalized digital sessions that dynamically adjust based on real-time feedback. In the entertainment industry, the system could be used to design immersive experiences where user interaction influences the course of the content. The platform's core features—customizable content creation, real-time engagement, and feedback—are designed to be adaptable across these diverse applications.

It is worth noting that allowing creators to input smaller sections at a time and letting the system assemble them provides additional benefits. Recording shorter sections reduces the likelihood of mistakes, and editing or replacing a smaller section does not impact other sections.

To provide a clearer understanding of this invention, a detailed embodiment is described below. It should be understood that there are many ways to implement the core concept mentioned above to achieve the same objective without deviating from the invention's principles. For the purpose of illustration, and without limitation, a mobile phone with the specially designed display interfaces shown in FIG. 3a-3h will be used as an example of the system. Additionally, the complex content creation and playback processes are broken down into several layers for clearer explanation.

### Content Creation Process

Creators begin by dividing a hypnotherapy session into smaller sections based on the following guidelines:
Each section must conclude with a clear instruction for users on how to input a response into the system.
The method of response must align with the system sensing capability.
The interaction inserted should be purposeful, directly contributing to the overall objective of the session.

The following example begins with segmented content, and content segmentation capability can be easily incorporated if needed.

FIG. 5 provides a top-level flowchart of the content creation process (14). The process begins (1400) when the creator clicks the ‘@’ button located at the lower center of the home page, as depicted in FIG. 3a. This action transitions the screen to the CREATE SESSION page (1402) shown in FIG. 3b, where the creator starts the session creation process (800), outlined in FIG. 6, by choosing either ‘RECORD A SECTION’ or ‘UPLOAD A SECTION’ (1403). Once the session creation process (800) is completed, the description page (1406) in FIG. 3h is displayed, and a content data package, as described in Table 1, is generated and updated (1404) with a pointer to the newly created session data package, detailed in Table 2.

On page 1406, the creator has the option to click the ‘+QUESTIONNAIRES’ button to design either a pre-session or post-session questionnaire (1045, 1407) using the questionnaire design process (400), which will be elaborated on later.

Upon creation, the questionnaire is displayed as an icon on page 1406, and the content data package is updated (1408) with a pointer to the new questionnaire data package, as specified in Table 5.

The creator can rearrange the questionnaire order by dragging the icons to place them before or after the session (1413, 1409), updating both the content data package and the questionnaire data package (1408). Once finalized, the content can be saved (1411) to local memory (10) with the ‘Save’ button (1414) on page 1406. When the creator clicks the ‘Submit’ button (1415), the content data package (Table 1) is stored in a database (1416) managed by the distribution process (11), which will be explained in detail below. Additional questionnaires can be added before submission by repeating steps 1407 through 1412.

It should be noted that all the flowcharts in this document are provided as exemplary embodiments of this invention. One or more of the processes shown in these flowcharts may be performed in a different order or concurrently to achieve the same objective. Additionally, the data package protocols demonstrated in the following description are provided solely for explanatory purposes. Different formats, contents, and sequences may be used to achieve the same result.

The content data package mentioned above contains the information listed in Table 1. For consistency, fields 1 and 2 of all data package examples described in this document are defined to store the data package type code and the total length of the data package in bytes, respectively. Field 3 of Table 1 contains a pointer to the description data package, defined in Table 4 below. Field 4 holds a pointer to the session data package, defined in Table 2 below. Field 5 specifies the number of pre-session questionnaires to be displayed before the session begins. The pointers to the pre-session questionnaire data packages are appended in fields 6 through 6+ (Field 5-1). If the value of Field 5 is 0, indicating no pre-session questionnaire, the next field after Field 5 will indicate the number of post-session questionnaires to be displayed after the session ends. The remaining fields will contain pointers to the post-session questionnaire data packages. A version of the questionnaire data package content is defined in Table 5 below.

TABLE 1
a conceptual example of a content data package.

| Field # | 1 | 2 | 3 |
|---|---|---|---|
| Field | content data | data package | *description data |
| description | package | length | package (Table 4) |
| 4 | 5 | 6 | 7 |
| *session data | # of pre-session | *pre-session | . . . |
| package | questionnaires | questionnaire1 | |
| (Table 2) | | (Table 5) | |
| 8 | 9 | 10 | 11 |
| # of post- | *post-session | *post-session | . . . |
| session | questionnaire1 | questionnaire2 | |
| questionnaires | | pointer | |

*denotes pointer.

### Session Creation Process

FIG. 6 illustrates a flowchart of the session creation process (800) mentioned above. This process begins with the section creation process (200), depicted in FIG. 7 below, where a new section is created. Once the section is created, it is displayed on page 802, as shown in FIG. 3g, and the session data package is updated with the newly added section (801). On page 802, the creator can rearrange the sections (804) by dragging the section icons up and down or left and right, connecting them according to a predefined playback order-such as top-down or left-right. Any order change triggers an update of the session data package (801). The creator can add more sections by clicking the ‘RECORD A SECTION’ or ‘UPLOAD A SECTION’ icons (806) on page 802, repeating steps 200 to 805. The ‘Preview’ button (808) allows the creator to preview the draft (809), while the ‘Save’ button (811) saves the content to local memory (812). After all sections are created and their order is finalized, the creator can click the ‘Describe’ button (814) on page 802, which proceeds to step 1404 of the content creation process in FIG. 5.

Table 2 presents an example of a session data package. In Table 2, Field 3 contains the ID of the first section to be played, while Field 4 holds the pointer to the first section's data package. A version of the section data package is defined in Table 3 below. The first section is identified as the top section in a top-down order or the leftmost section in a left-right order. All subsequent section IDs and data package pointers are packed in Field 5 and beyond.

TABLE 2
a conceptual example of a session data package contents.

| Field # | 1 | 2 | 3 | 4 |
|---|---|---|---|---|
| Field | Session | Session | 1st section | *id1 section |
| description | data package | data package | id1 | data (Table 3) |
| | | length | | package |
| 5 | 6 | 7 | 8 | 9 |
| Section id2 | *id2 section | . . . | Section idn | *idn section |
| | data package | | | data package |

### Section Creation Process

FIG. 7 illustrates a flowchart of the section creation process (200) mentioned above. Once a section is recorded or uploaded (201), the screen page (214), as shown in FIG. 3c, is displayed. The creator can review the section by clicking the ‘>’ button at the lower center and either accept and save it by clicking ‘V’, or discard it by clicking ‘X’ at the bottom of the screen (214) and input a new section. Once a section is accepted (202), the screen (210) of FIG. 3d is displayed, prompting the creator to optionally add an interaction period (203) at the end of the section. If ‘X’ (No) at the bottom of page (210) is clicked, the process skips to step 209, and a section data package, defined in Table 3, is created and saved to memory without an interaction period. If ‘V’ (Yes) is clicked, an interaction period is added to the end of the section. The creator can set a custom wait timeout and number of answer choices (or next branches) (217) on page 210, which will be saved (204) to memory. Then, page (211) of FIG. 3e is displayed, prompting the creator to optionally record a reminder (205), which plays during the interaction period to re-engage the user if no response is received within a reminder repetition interval. The creator can configure a custom reminder repetition interval (215, 206), which must be shorter than the wait timeout. By clicking ‘V’ (Yes) on page 211, the reminder is recorded (216, 207), and the display transitions to page 212 in FIG. 3f during the recording process. Once the reminder is accepted (208) by clicking ‘V’ on page 212, a section data package, as defined in Table 3, is generated and saved (209) to local memory (10), including both the interaction period and the reminder. If ‘X’ (No) is selected on page 211, the same section data package is created, but without a reminder. The process then moves to step 801 of the session creation process, as shown in FIG. 6.

Table 3 presents an example of a section data package.

TABLE 3
a conceptual example of a section data package contents.

| Field # | 1 | 2 | | 3 | 4 |
|---|---|---|---|---|---|
| Field | Section | Data package length | | This | Wait |
| description | data | | | section | inserted |
| | package | | | ID # | flag |
| 5 | 6 | 7 | | 8 | 9 |
| Wait | Reminder | Reminder playback | | # of | Answer1 |
| timeout | inserted | Interval (sec) | | answer | next id |
| (min) | flag | | | choices | |
| 10 | 11 | 12 | 13 | 14 | 15 |
| . . . | AnswerN | Section | Recorded | Reminder | Recorded |
| | next id | data | section | length | reminder |
| | | length | data | | |

As shown in Table 3, the section data package includes the following information: the unique ID number of the section (Field 3), a ‘wait inserted flag’ (Field 4), the wait timeout length (Field 5), a ‘reminder inserted flag’ (Field 6), and the reminder playback interval (Field 7), which is set to 0 if the ‘wait inserted flag’ or the ‘reminder inserted flag’ is not set. The ‘#answer choices’ (Field 8) indicates how many different responses a user can provide when prompted at a stop-wait-sense-go (SWSG) point. For example, if the UI device (15) can distinguish between two different user inputs, such as scrolling the screen up or down, the creator can design the system to expect two answer choices (‘yes’ and ‘no’), and the ‘#answer choices’ would be set to 2. Different user responses may lead to different subsequent sections, represented as ‘answer 1 next ID’ (Field 9), ‘answer 2 next ID’ (Field 10), and up to ‘answer N next ID’ (Field 11). By default, the next IDs are set to 0, indicating that this section is the last one in the hypnotherapy session.

Field 12 holds the section data length, which represents the total number of bytes in the recorded section, followed by the recorded section data in Field 13. Field 14 holds the reminder length in bytes, followed by the recorded reminder in Field 15. If the ‘reminder inserted flag’ (Field 6) is not set, the reminder length is set to 0 and Field 15 does not exist. If the ‘wait inserted flag’ is not set, this section does not wait for a user response. If this is the last section, the ‘#answer choices’ is set to 0. Otherwise, it is set to 1, indicating there is only one next section ID, which points to the next section to be played.

### Description Data Package

After creating a session, the creator can proceed by clicking the ‘Describe’ button at the lower right corner of the page in FIG. 3g, which brings up the description page shown in FIG. 3h. The creator is then prompted to add a description of the created session. An example of the information collected is listed in the description data package shown in Table 4. Depending on the specific situation and personal preference, different information can be collected and arranged in the description data package in varying orders.

TABLE 4
a conceptual example of the contents in a session description data package.

| Field # | 1 | 2 | 3 | 4 | 5 | 6 |
|---|---|---|---|---|---|---|
| Field | Description | Data package | Title | Title | Author name | Author |
| description | data package | length | length | data | length | name |
| 7 | 8 | 9 | 10 | 11 | 12 | 13 |
| Language | Description | Description | Category | Payment | Currency type | amount |
| code | length | data | code | code | | |

Besides the self-explanatory Fields 1 to 9, Field 10 contains the service category code for which the hypnotherapy is designed, such as anxiety relief, stress reduction, or weight loss. Field 11 represents the pricing model chosen by the creator, such as free, pay-per-view, or subscription-based. The last two fields are the currency type (Field 12) and the pricing amount (Field 13). The payment information in Fields 11-13 is used by the distribution process (11) to manage payments and content distribution. All this information can be made available to users when the content is published.

### Questionnaire Design Process

In therapy, it is common practice to evaluate a client's behavioral habits and preferences using specially designed questionnaires. Different answer choices to questions are weighted according to specific criteria, and a final score is calculated and compared against a set of empirical values for assessment. Incorporating a feedback collection mechanism into every digital session provides significant value for therapy efficacy research and big data analysis. Another key application of session-related feedback is the fine-tuning of a therapy-specific AI language model.

As mentioned in the Content Creation Process section above, on the description page shown in FIG. 3h, creators have the option to design customized questionnaires that can be displayed to users either before or after a session. Pre-session questionnaires can be used to screen users for appropriate sessions, for example, sessions specifically designed for certain age groups, ethnicities, or professions.

The process of creating a customized questionnaire is illustrated in FIG. 8. Page 402, as depicted in FIG. 4a, shows the questionnaire design interface screen, where the creator can add or delete questions (404) by clicking the ‘⊕’ or ‘⊖’ buttons respectively (405). The creator can also enter other settings (411), such as the number of answer columns, column titles, assign scores to each answer, and define a formula to calculate the final score (403). The questionnaire data package, illustrated in Table 5, is updated in real-time as new inputs are received. The ‘Preview’ button at the bottom of page 402 brings up (412) the preview page (407), shown in FIG. 4b, where the ‘<’ button returns the creator to page 402.

Once all questions are added, the created questionnaire data package, defined in Table 5, can be saved to memory (409) by clicking the ‘Save’ button (413) on page 402. The saved questionnaire icons will then appear on the description page of FIG. 4c (410), where the creator can arrange the questionnaire display order by dragging the icons to position them either before or after the session. Changing the order will update the ‘pre/post session’ field in the questionnaire data packages. Finally, the process continues to step 1048 in FIG. 5.

Table 5 shows an example of the questionnaire data package. The one-bit ‘pre/post Q flag’ (Field 3) indicates whether the questionnaire should be displayed before or after the session. This field is adjusted whenever the questionnaire display order is changed relative to the session playback time. If placed before the session on the page shown in FIG. 4c, the ‘pre/post Q flag’ is set to 0; otherwise, it is set to 1, and the questionnaire will be displayed after the session. Field 4 contains the unique questionnaire ID. The ‘algorithm code’ (Field 5) represents the formula used to calculate a final score based on the answer scores for each question. In addition to a few default algorithms, such as total sum or average, creators can define their own algorithm by providing an ‘algorithm description’ (Field 7). This description can be a formula, a block of code, or simple text, which can be converted into computer code using an AI coding plug-in. Field 6 specifies the length of the algorithm description text. The ‘#of answers for every Q’ (Field 8) indicates the number of answer choices for each question, with each answer assigned a unique score, stored in Fields 9 to (9+(Field 8-1)). The ‘#of Qs’ (Field 11) represents the total number of questions in the questionnaire. The ‘1st question length’ (Field 12) specifies the number of bytes for the text of the first question, which is stored in Field 13. Field 14 and beyond contain subsequent questions.

TABLE 5
a conceptual example of a questionnaire data package contents.

| Field # | 1 | 2 | 3 | 4 |
|---|---|---|---|---|
| Field | Questionnaire | data | pre/post Q | Questionnaire |
| description | data package | package | flag | ID |
| | | length | | |
| 5 | 6 | 7 | 8 | 9 |
| Algorithm | Algorithm | Algorithm | # of | Score |
| code | description | description | answers | assigned to |
| | length | | for every | 1st answer |
| | | | Q | |
| 10 | 11 | 12 | 13 | 14 |
| . . . | # of Qs | 1st | 1st | . . . |
| | | question | question | |
| | | length | text | |

### Systems and Methods for Users

As shown in FIG. 1, the content playback process (12) delivers the created content to users via UI devices (15), a conceptual block diagram of which is illustrated in FIG. 9. The UI devices (15) include a speaker, a timer, a display screen, and input collection devices (e.g., microphone, camera, touch screen) for capturing user responses. They are also equipped with data ports for transferring data to and from the storage units (10) and the computing device (16).

Without limitation, in the following description, a mobile phone with specially designed display interfaces, one version of which is illustrated in FIGS. 10a-10f, is used as an embodiment of the UI device (15). A mobile phone has access to both local and remote data storage and provides standard UI device control and platform management services.

### Content Playback Process

FIG. 11 presents a flowchart example of the content playback process (12). On the user home screen (FIG. 10a), clicking on one of the session icons (e.g., ‘hypnosis experience’) initiates (1200) the playback process on the mobile phone. The content data package (1213) is parsed according to the protocol defined in Tables 1-5 to determine whether pre-session questionnaires need to be displayed (1201). If so, the question texts are retrieved from the corresponding questionnaire data package (Table 5) and displayed on page 1202, as illustrated in FIG. 10e. After the user's answers are collected and analyzed (1203), the results are displayed on the same page (1202) or on a separate results page. If no pre-session questionnaire is required, the process skips to 1204, displaying several pre-session instruction pages (1217), with an example shown in FIG. 10b. At the end of the instructions, the screen (1206) in FIG. 10c prompts the user to tap (1215) to start the session playback process (600), which will be explained below.

Once the session playback process (600) is completed, post-session questionnaires are displayed (1208) if included in the content data package (1207). The user's answers are collected, and the analysis results are displayed (1211) on the end page (1212), shown in FIG. 10f. If there are no post-session questionnaires, a simple ‘the end’ page (1210) from FIG. 10g is displayed instead. Both the results page (1212) and the end page (1210) conclude the content playback process.

A biofeedback signal can be used to influence the playback process. For example, if a very high heart rate is detected during the session, the process may be interrupted, optionally displaying an emergency instruction (1216) before concluding the session (1209, 1210).

### Session Playback Process

FIG. 12 illustrates an example flowchart of the session playback process (600). The process begins by playing the first section (601), which is retrieved from the session data package defined in Table 2, and displaying screen 603 as shown in FIG. 10d. At the end of the first section, the ‘wait inserted flag’ in the section data package, as defined in Table 3, is checked (602). If the flag is not set, meaning there is no need to wait for user confirmation, the process jumps to step 612. If the flag is set, indicating that a user response is required before proceeding to the next section, the necessary sensors (such as the touch screen or microphone) and a timer within the mobile phone are activated (604) to capture the user response and count down the wait timeout period, respectively.

Next, the ‘reminder inserted flag’ in the section data package is checked (605). If the flag is set, a separate timer starts counting down the reminder repetition interval (606). If the ‘reminder inserted flag’ is not set, the process moves directly to step 607 to check whether a user response has been received. If no response is received and the timers have not been triggered (609, 611), the process returns to step 607 and repeats steps 607-611. If the reminder interval timer triggers before a user response is received, the recorded reminder is played, and the timer is reset to begin counting down the next interval.

As mentioned earlier, depending on the system's sensing capabilities, users may be prompted to provide multiple-choice responses, such as a simple ‘yes’ or ‘no’, with each response leading to a different next section ID. If a user response is received, the corresponding next section ID is retrieved (608), and the process jumps to step 613. If the timeout period expires before a response is received, a default next section ID is selected, which, by design, is the first next section ID found in Field 9 of Table 3. If the next section ID is not equal to 0, the process returns to step 601 to play the next section. This loop, from step 601 to step 613, continues until the next section ID equals 0, indicating the session playback process is complete, at which point the process moves to step 1207 of the content playback flowchart in FIG. 11.

### System Level Processes

The purpose of the system-level processes is to bridge the systems and methods for creators and users while making the invention scalable, allowing it to accommodate a large number of both creators and users.

### Distribution Process

As mentioned earlier, the Distribution Process (11 in FIG. 1) manages the content review process for publication and handles payment accounts for playback control.

For explanation purposes, a mobile phone with the same display interface design demonstrated in previous sections (FIGS. 3a-3h, 4a-4c and 10a-10g) is used as the system embodiment in the following description.

FIG. 13 illustrates an example flowchart of the distribution process. When a created content is submitted, the distribution process begins (1100), placing the submitted content in a queue awaiting review (1101). If approved, the content is published and made available (1105) on the user home page (1106) shown in FIG. 10a, and the created content data package is saved in the published content database (1103) within the storage units (10). If rejected, the creator is notified of the denial (1104), and the content is either discarded or saved in a rejected content database in the storage units.

When a user clicks on a content icon on the user home page (1106), the description data package (defined in Table 4) of that content is parsed to retrieve the payment terms. If the payment terms are met, the user's payment records are updated (1109), and the playback process for that content is initiated. Otherwise, the user is prompted to complete payment, and the content will not be played.

### Creator/User Account Management Process

The Creator/User Account Management Process (13 in FIG. 1) is responsible for tracking and managing the activities, attributes, and relationships between creators and users. In a multi-user platform, these processes include:

### 1. Creator Account Management:

Content Management:
Creators typically have a published content list, which shows their active content available to users, as well as a draft list, where works-in-progress are saved. The system also maintains a denied content list, capturing content rejected by the platform, often accompanied by reasons for rejection and feedback.
Earning History:
This tracks revenue earned by the creator, including income from different content types such as pay-per-view, subscription-based content, or ad revenue. The system may display analytics for earnings by content and time-based breakdowns (daily, weekly, monthly).
Fan Base and Engagement:
Creators can monitor their fan base, including follower counts, growth over time, and engagement metrics such as likes, shares, and comments. The system might also provide insights into audience demographics (e.g., age, location) and engagement levels across various content types.
Content Performance Analytics:
These metrics provide feedback on how content is performing, including views, completion rates, user ratings, and feedback. Creators can use these insights to refine content creation strategies and improve user satisfaction.

### 2. User Account Management:

Listening and Viewing History:
The platform keeps track of each user's listening and viewing history, showing the sessions they've completed or paused. This feature helps users resume where they left off and revisit past content. It also provides data for recommending similar content.
Purchased Content and Subscriptions:
Users have access to a purchased content list, showing content they've bought and available for re-access. If the platform supports subscriptions, the system will track user subscriptions to creators or specific content packages.
Followed Creators:
Users can follow creators to receive notifications about new content. The followed creator list helps users quickly access content updates and special offerings.
Payment History and Preferences:
The system tracks all transactions, including one-time payments, subscription fees, and refunds, allowing users to review their payment history. The platform may also store payment preferences (e.g., credit card or PayPal details) for smoother future transactions.
Recommendations and Personalization:
Based on the user's interaction patterns (e.g., content viewed, searches, engagement with specific creators), the system can offer personalized recommendations to enhance user experience, powered by recommendation algorithms or machine learning.

### Platform Management Process

The Platform Management Process (18 in FIG. 1) ensures the smooth operation and synchronization of various devices, services, and processes on the platform. Key functions include:

### 1. System and Method Configuration:

This process is responsible for configuring various system settings, such as content formats, server allocations, user permissions, and platform-wide policies. It involves setting up the methods by which content is ingested, processed, and delivered to users. This also includes configuring device compatibility for the platform (e.g., mobile phones, tablets, and computers).

### 2. Device and Process Scheduling:

The platform needs to manage resource allocation for device usage, content playback, and content creation processes. Scheduling is crucial in handling large numbers of concurrent users and creators, ensuring seamless access to system resources (e.g., server capacity, memory).
Scheduling processes may include setting content publication dates for creators, organizing the processing of content review queues, and prioritizing user access during peak traffic times.

### 3. Synchronization:

Synchronization ensures that multiple devices and systems (e.g., storage units, computing devices, user devices) are working together in real time. For instance, if a user pauses a session on one device, synchronization allows them to resume it on another without losing progress.
This also applies to data synchronization between storage units (e.g., cloud-based storage) and local devices to ensure consistent access to content and account data across platforms.
Additionally, synchronization manages the interaction between back-end processes like content updates, user data analysis, and system maintenance with the front-end, ensuring that updates (e.g., new content availability, system enhancements) reflect seamlessly across all user and creator interfaces.

### 4. Security and Data Privacy Management:

The platform management process includes setting up security protocols to protect user and creator data, including encryption of sensitive information (e.g., payment details, personal information).
User access controls and content moderation also fall under this process, ensuring that inappropriate content is filtered, and user data is handled in compliance with relevant data privacy laws (e.g., GDPR, CCPA, HIPAA).

### 5. Analytics and Reporting:

This process ensures the collection and analysis of platform-wide data, including performance metrics of content, user activity, and server health. Reports generated can help system administrators optimize platform performance and plan for future growth.

### 6. Updates and Maintenance:

Routine maintenance tasks are scheduled to update software, apply security patches, and perform system backups. This ensures minimal downtime for users and creators while keeping the platform running smoothly and securely.

1. A system for creating and delivering interactive multimedia sessions, comprising:
one or more creator interface devices configured to input multimedia content (audio, video, images, and text), design user interaction periods, create customizable feedback mechanisms including questionnaires, and preview designed content;
one or more user interface devices configured to deliver the multimedia content and collect user responses during interaction periods and through customizable feedback mechanisms;
a storage medium operatively connected to the creator and user interface devices to store multimedia content, interaction periods, user responses, and the feedback data;
one or more computing devices configured to:
compile multimedia content, interaction periods, and feedback mechanisms into a content data package according to a predefined protocol;
manage the scalable delivery of the content data package to multiple user interfaces;
analyze user responses during interaction periods and through feedback mechanisms to optimize future multimedia content delivery;
manage platform resources, user accounts, and content distribution processes.

2. A method for creating and delivering interactive multimedia content across a scalable platform, comprising:
receiving multimedia inputs from a creator via a creator interface device;
dividing the multimedia inputs into sections, each optionally associated with at least one interaction period designed to engage users;
configuring custom feedback mechanisms, including but not limited to pre-session and post-session questionnaires, to collect user responses;
delivering multimedia content to multiple users through scalable user interface devices; and
analyzing user responses to refine future content.

3. The system of claim 1, wherein the creator interface device is further configured to design customizable feedback mechanisms, including questionnaires, surveys, and real-time interactive polls, with options for question types, response formats, scoring algorithms, and dynamic content adjustments based on creator interaction.

4. The system of claim 1, wherein the feedback mechanisms, including questionnaires, are dynamically arranged and integrated into the session content, allowing creators to adjust the presentation and order of feedback relative to content playback.

5. The system of claim 1, wherein user responses are analyzed using artificial intelligence (AI) to generate personalized content recommendations and adapt future sessions based on individual and aggregate user data across the platform.

6. The system of claim 1, further comprising biofeedback control mechanisms that can dynamically adjust or interrupt content playback at any point during the session based on real-time user physiological data, such as heart rate or stress level.

7. The system of claim 1, wherein the computing device manages scalable content distribution, ensuring efficient playback for multiple users and seamless delivery of multimedia sessions in real time across various user interface devices.

8. The system of claim 1, wherein the computing device supports synchronization of user progress across multiple devices, allowing users to pause and resume sessions without loss of progress.

9. The system of claim 1, further comprising a content approval and review process to ensure that specific content, such as educational or therapeutic content, is vetted and ready for distribution across the platform.

10. The system of claim 1, wherein the computing device supports cloud-based storage for content and user feedback data, allowing for dynamic scaling as the number of users and creators increases.

11. The system of claim 1, wherein the computing device manages distributed database systems to store user responses, feedback data, and multimedia content, supporting scalable data management across multiple users and devices.

12. The system of claim 1, further comprising a platform management process for handling configuration, scheduling, and synchronization of system resources across multiple users and creators.

13. The platform management process of claim 12 includes scalable load balancing and resource allocation to ensure seamless content delivery during periods of high traffic, supporting large-scale user interaction.

14. The system of claim 1, further comprising a creator and user account management process that tracks content creation, user activities, preferences, and monetization of content.

15. The method of claim 2, further comprising the step of configuring a reminder during interaction periods to enhance user engagement by prompting responses if no input is received within a predefined time interval.

16. The method of claim 2, further comprising the step of configuring custom scoring algorithms within the feedback mechanisms to automatically calculate user results based on their inputs, supporting large-scale feedback analysis.

17. The method of claim 2, further comprising the step of designing custom feedback questionnaires that can be deployed across multiple users concurrently, enabling scalability while maintaining personalized content delivery.
